(19) United States
(12) Patent Application Publication
(10) Pub. No.: US 2025/0171205 A1
(43) Pub. Date: May 29, 2025

(54) LINER FOR FOOD RECEIVER OF FOOD HOLDING APPARATUS

(71) Applicant: Duke Manufacturing Co., St. Louis, MO (US)

(72) Inventor: Sai Ravi Krishna Subramani, Houston, TX (US)

(21) Appl. No.: 19/040,434

(22) Filed: Jan. 29, 2025

Related U.S. Application Data
(63) Continuation of application No. 18/324,462, filed on May 26, 2023, now Pat. No. 12,240,654.
Application No. 18/324,462 is a division of application No. 17/586,237, filed on Jan. 27, 2022, now Pat. No. 11,912,465.
(60) Provisional application No. 63/142,127, filed on Jan. 27, 2021.

(51) Int. Cl. B65D 25/16; A47G 23/06; B65D 1/34

(52) U.S. Cl. CPC B65D 25/16; A47G 23/06; B65D 1/34

(57) ABSTRACT

Food holding system, liner thereof, and associated methods. A food tray receiver liner is configured to be installed in a food tray receiver. The liner is configured to collect food that may fall into the food tray receiver. Desirably, the liner obstructs food from passing between the liner and side walls of the food tray receiver.

### CROSS-REFERENCE TO RELATED APPLICATIONS

The present application claims priority to and is a continuation of U.S. application Ser. No. 18/324,462, filed May 26, 2023, which claims priority to and is a divisional of U.S. application Ser. No. 17/586,237, filed Jan. 27, 2022, issued as U.S. Pat. No. 11,912,465, which claims priority to U.S. Provisional Application No. 63/142,127, filed on Jan. 27, 2021, the entireties of which are hereby incorporated by reference.

### FIELD

The present disclosure generally relates to liners for food handling equipment and more particularly to a liner for food holding apparatuses.

### BACKGROUND

Food holding apparatuses, such as countertop food holding apparatuses, are commonly used in restaurants and kitchens, such as part of a buffet or serving line, to hold prepared food at a set temperature before the food is served to a consumer.

### SUMMARY

In one aspect, a liner is for a food tray receiver of a food holding apparatus. The food tray receiver has a plurality of food tray receiver side walls defining a food tray receiver cavity for receiving one or more trays of food. The liner comprises a flexible body sized and shaped to be inserted into the food tray receiver cavity of the food tray receiver. The flexible body has a base and a plurality of body side walls extending generally upward from the base. The flexible body has a food receiving cavity defined by the base and the plurality of body side walls. The food receiving cavity has an open top configured to receive food when the flexible body is disposed in the food tray receiver and food falls toward the flexible body. The body side walls are configured to move into engagement with the food tray receiver side walls to generally prevent food from moving between the food tray receiver side walls and the body side walls when the flexible body is disposed in the food tray receiver cavity of the food tray receiver.

In another aspect, a method includes using a liner with a food tray receiver of a food holding apparatus. The food tray receiver has a floor and a plurality of food tray receiver side walls defining a food tray receiver cavity for receiving one or more trays of food. The method comprises placing the liner in the food tray receiver cavity. The liner comprises a flexible body sized and shaped to be inserted into the food tray receiver cavity of the food tray receiver. The flexible body has a base and a plurality of body side walls extending generally upward from the base. The flexible body has a food receiving cavity defined by the base and the plurality of side walls. The food receiving cavity has an open top configured to receive food when the flexible body is disposed in the food tray receiver and food falls toward the flexible body. The method includes forming a seal between the side walls of the flexible body and the food tray receiver side walls to generally prevent food from moving between the food receiver side walls and the body side walls.

In another aspect, a liner is for a food tray receiver of a food holding apparatus. The food tray receiver has a plurality of food tray receiver side walls defining a food tray receiver cavity for receiving one or more trays of food. The liner comprises a flexible body sized and shaped to be inserted into the food tray receiver cavity of the food tray receiver. The flexible body has a base and a plurality of body side walls extending generally upward from the base. The flexible body has a food receiving cavity defined by the base and the plurality of body side walls. The food receiving cavity has an open top configured to receive food when the flexible body is disposed in the food tray receiver and food falls toward the flexible body. The body side walls are configured to engage the food tray receiver side walls when received in the food tray receiver cavity to obstruct food from moving between the food tray receiver side walls and the body side walls. The body side walls taper outward as the body side walls extend generally upward away from the base.

Other objects and features will be in part apparent and in part pointed out hereinafter.

### BRIEF DESCRIPTION OF THE DRAWINGS

FIG. 1 is a perspective of a food holding apparatus;

FIG. 2 is a perspective of a food receiver pan of a food receiver of the food holding apparatus;

FIG. 3 is a cross section of the food receiver pan taken through line 3-3 of FIG. 2;

FIG. 4 is a perspective of a liner according to one embodiment of the present disclosure;

FIG. 5 is a perspective of the liner in the food receiver pan;

FIG. 6 is a cross section of the liner in the food receiver pan before the liner deforms to form a seal with the food receiver pan; and

FIG. 7 is a cross section of the liner in the food receiver pan after the liner has deformed to form the seal with the food receiver pan.

Corresponding reference characters indicate corresponding parts throughout the drawings.

### DETAILED DESCRIPTION

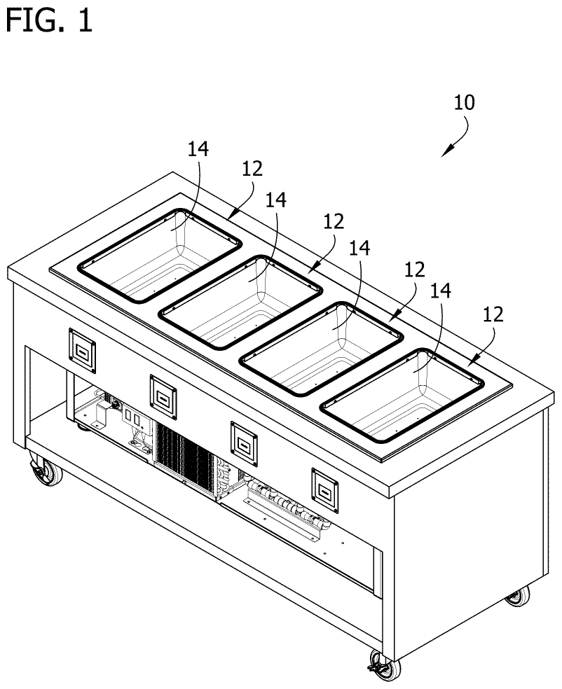

Referring to the drawings, FIG. 1 illustrates a food holding apparatus 10. The food holding apparatus 10 is used to hold trays of prepared or ready to serve food at set (e.g., hot or cold) temperatures. The food holding apparatus 10 includes one or more food receivers 12, sometimes referred to as food holding wells or pans. The food receivers 12 may be referred to as food tray receivers. In the illustrated embodiment, the food holding apparatus 10 includes four food receivers 12, with each of the food receivers being generally identical. The food receivers 12 receive and hold the trays of food (not shown). For example, a food tray may have an upper flange by which the tray “hangs” down into the food receiver 12. The food holding apparatus 10 may include a heating system and/or cooling system for heating and/or cooling each food receiver 12 and the one or more trays of food received and held therein. The heating system (not shown) may include a heater, such as an electrical resistance heater, underlying a floor of each food receiver 12. The cooling system may include a refrigeration system with one or more cooling coils (e.g., cooling conduit extending around the food receiver). Such a heater and cooling coils may each be broadly referred to as a food receiver temperature conditioning element. One or both of the heater or cooling coil may be omitted without departing from the scope of the present disclosure. Further details on an example food holding apparatus may be found in U.S. patent application Ser. No. 17/448,899, filed Sep. 27, 2021, the entirety of which is hereby incorporated by reference.

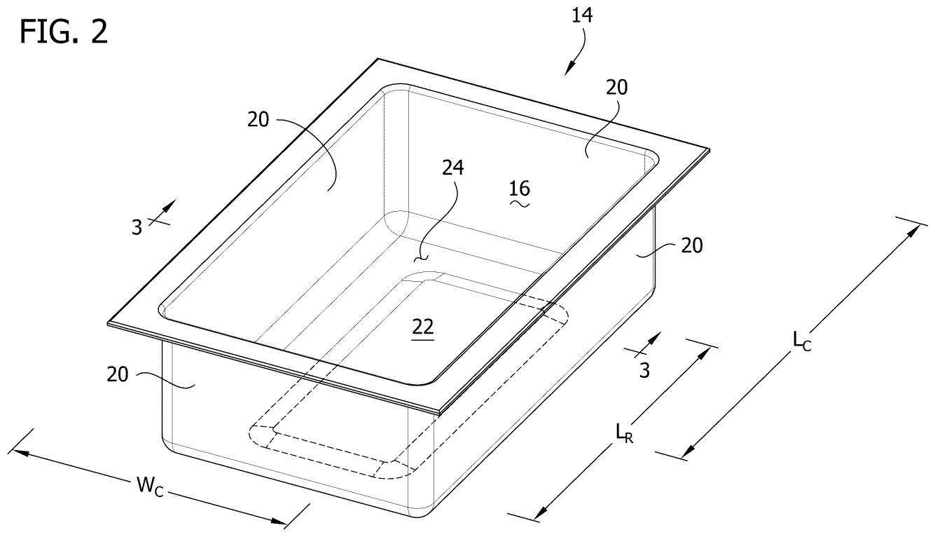

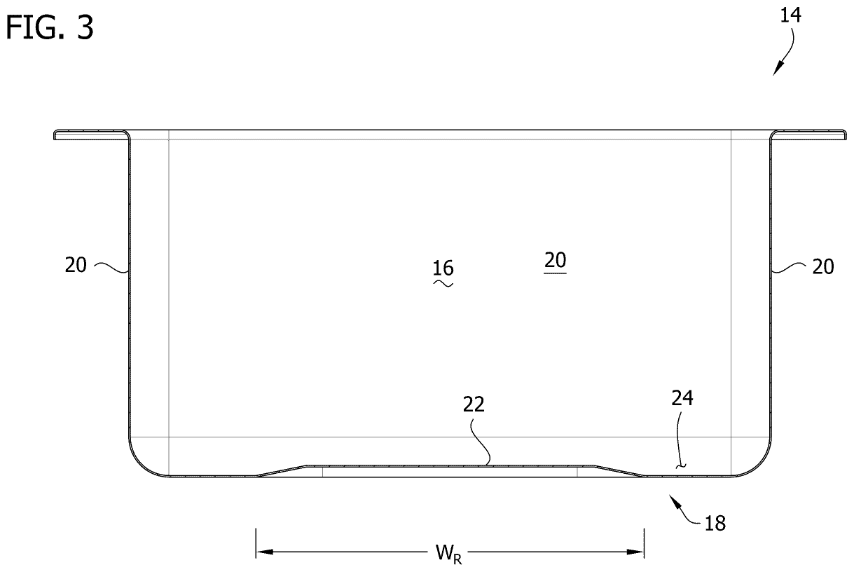

Referring to FIGS. 2 and 3, each food receiver 12 includes a food receiver pan 14. The food receiver pan 14 defines a food receiver cavity 16 in which the one or more trays of food are receivable. The food receiver cavity 16 can be sized and shaped to receive one or more of generally any size of food tray (sometimes also referred to as food pans) such as a full size food tray (about 20.75″×12.75″), a two-thirds size food tray (about 13.75″×12/75″), a half size food tray (about 12.75″×10.375″), a one-third size food tray (about 12.75″×6.875″), etc. The food receiver pan 14 includes a floor 18 and a plurality (e.g., four) food receiver side walls 20 extending upward from the floor. The floor 18 includes a centrally located raised portion or plateau 22 spaced inward from the food receiver side walls 20. The food receiver pan 14 includes a perimeter or peripheral recess or trough 24 extending around the raised portion 22, between the raised portion and the food receiver side walls 20. The side walls 20 intersect or join with each other at the corners of the food receiver cavity 16. In the illustrated embodiment, the corners of the food receiver pan 14 defined by the intersections of the food receiver side walls 20 are rounded or curved. Other configurations of the food holding apparatus 10 and the food receivers 12 can be used without departing from the scope of the present disclosure.

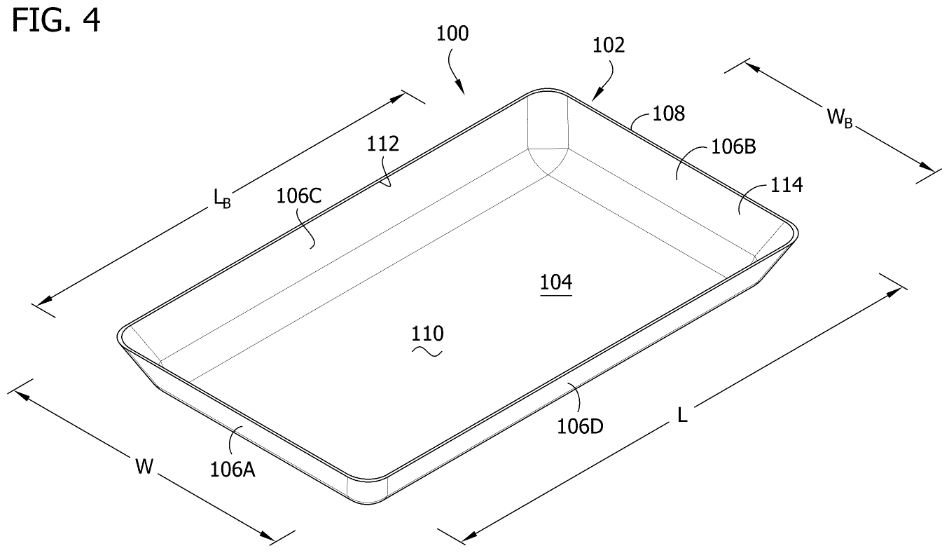

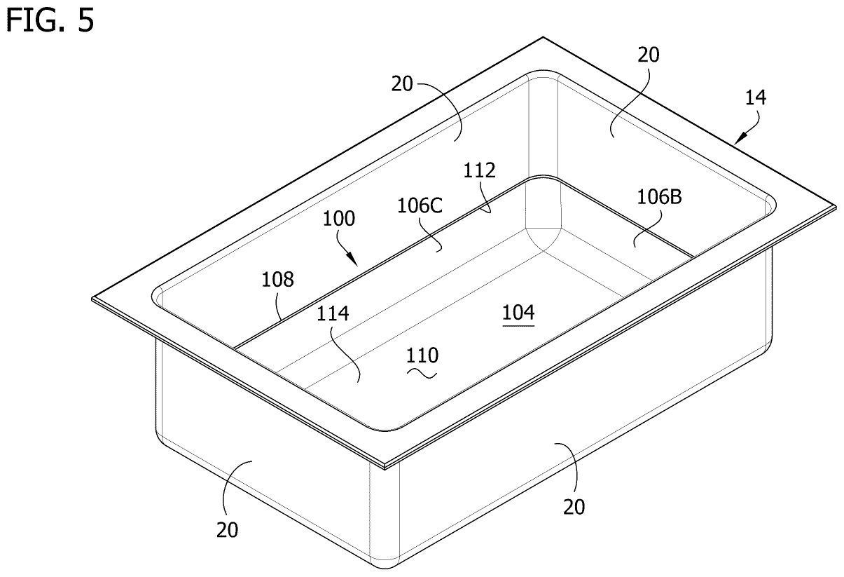

Referring to FIGS. 4 and 5, a liner according to one embodiment of the present disclosure is generally indicated by reference numeral 100. The illustrated liner 100 is designed for use with the food tray receivers 12 of the food holding apparatus 10 of FIGS. 1-3, however it is understood the liner can be designed for use with other food receivers. The liner 100 is sized and shaped to fit in the food receiver cavity 16 of the food receiver 12 and engage the food receiver side walls 20 of the food receiver. When disposed in the food receiver 12, the liner 100 rests on the floor 18 of the food receiver and generally forms a seal (e.g., a perimeter seal), such as a liquid tight or food tight seal, with the food receiver side walls 20 and corners of the food receiver. Desirably, the liner 100 seals against all of the food receiver side walls 20 (e.g., the front, rear, left, and right side walls) and the corners defined by the food receiver side walls to form a complete perimeter or peripheral seal around the food receiver cavity 16. However, it will be understood that sometimes a perfect fit may not be achieved, resulting in peripheral seal segments extending along one or more of the food receiver side walls 20 and/or corners with one or more gaps between the peripheral seal segments. No matter whether a complete peripheral seal is made, desirably the liner helps prevent most/all food (solids and/or liquids) from moving (e.g., flowing, falling) in-between the liner 100 and the food receiver side walls 20 of the food receiver 12. Food or liquid that falls into the food receiver cavity 16 of the food receiver 12 (e.g., food that spills out of the tray of food when the tray is being inserted into or removed from the food receiver cavity) is collected by the liner. The liner 100 can then be easily removed from the food receiver 12 (e.g., food receiver cavity 16) for easy cleaning. When the food receiver 12 is used with the liner 100, the food receiver will usually be used in a “dry” fashion without holding a bath of water to facilitate the heating and/or cooling of the food receiver. As known in the art, food receivers 12 may sometimes be filled with a bath of water to provide “wet” heat to the trays of food (e.g., heating the water bath which in turn heats the trays of food) or left empty to provide “dry” heat to trays of food (e.g., heating the trays of food without a water bath).

The liner 100 includes a flexible body 102 sized and shaped to be inserted into the food receiver cavity 16 of the food receiver 12. The flexible body 102 has a generally rectangular shape, to correspond to (e.g., match) the generally rectangular cross-sectional shape of the food receiver cavity 16. It is understood the flexible body 102 can have other shapes to correspond to other shapes of food receiver cavities. The flexible body 102 includes a liner base 104 (e.g., liner lower wall or liner floor) and a plurality of side walls 106 extending generally upward from the base. The base 104 is generally planar (when the entirety of the base is supported by a planar surface). The base 104 is generally rectangular with opposite left and right side edge margins and opposite forward and rear side edge margins. In the illustrated embodiment, the side walls 106 include four side walls, opposite front and rear side walls 106A, 106B and opposite left and right side walls 106C, 106D. The front side wall 106A extends from the front side edge margin of the base 104, the rear side wall 106B extends from the rear side edge margin of the base, the left side wall 106C extends from the left side edge margin of the base, and the right side wall 106D extends from the right side edge margin of the base. The front, rear, left and right side walls 106 are coupled together at corners of the flexible body 102. In the illustrated embodiment, the corners are rounded to correspond to the rounded corners of the food receiver cavity 16 of the food receiver 12. Together, the side walls 106 (e.g., upper edge margins thereof) define a continuous, unbroken rim 108 (e.g., upper edge margin) of the flexible body 102. The size and shape of the rim 108 generally corresponds to the size and shape of the cross-sectional perimeter of the food receiver cavity 16. In the illustrated embodiment, each side wall 106 includes a lower section that extends from the base 104 and curves generally upward to a planar upper section of the side wall.

Each side wall 106 tapers outward, as the side wall extends generally upward from the base 104 toward the open top 112 of the food receiving cavity 110. That is, as the front and rear side walls 106A, 106B extend generally upward away from the base 104, the front and rear side walls taper outward, away from each other. Likewise, as the left and right side walls 106C, 106D extend generally upward away from the base 104, the left and right side walls taper outward, away from each other. Thus, each side wall 106 extends at a skew angle with respect to vertical. As explained in more detail below, the tapering of the side walls 106 facilitates the movement of the side walls toward the food receiver side walls 20 to form the seal between the liner 100 and the food receiver 12.

The flexible body 102 has a food receiving cavity 110. The food receiving cavity 110 is defined by the base 104 and the side walls 106. The food receiving cavity 110 is configured to receive, collect and hold food that may fall into to the food receiver cavity 16 while the food holding apparatus 10 is in use. The food receiving cavity 110 has an open top or mouth 112 at the upper end of the flexible body 102. The open top 112 is configured to receive food when the liner 100 is disposed in the food receiver 12 and food falls into the food receiver cavity 16, toward the liner. When the liner 100 is positioned in the food receiver 12, the open top 112 catches food, or more particularly desirably catches all the food, that falls into the food receiver. The open top 112 is longer, wider, and larger (e.g., length x width, area) than the base 104. The flexible body 102 includes an interior surface 114 that defines the food receiving cavity 110. The interior surface 114 is defined by (e.g., extends over) the base 104 and the side walls 106. Desirably, the interior surface 114 is free of any crevices and/or sharp corners to facilitate cleaning the liner 100. The lack of crevices and/or sharp corners makes the liner 100 easy to clean.

The flexible body 102 comprises (e.g., is partially or entirely formed of) a flexible material, such as silicone or other suitable materials. Desirably, the flexible body 102 is a unitary, one-piece component. For example, the flexible body 102 can be made entirely of silicone or reinforced silicone (e.g., having fiberglass reinforcement therein). Silicone also has the added benefit of being easy to clean, as it has a relatively non-stick surface. In other embodiments, the flexible body may be made of multiple pieces joined together. It will be understood that the flexible body may be a composite structure or otherwise include some relatively rigid portions and other non-rigid or flexible portions.

The flexible body 102 is sufficiently flexible to permit deformation of the flexible body (e.g., deformation of the base 104 and the side walls 106). Desirably, the flexible body 102 is sufficiently flexible to be deformed when the liner 100 is in the food receiver cavity 16. For example, the base 104 may generally conform to the shape of the floor 18 of the food receiver 12 when the liner 100 is placed in the food receiver cavity 16 and supported by the floor. The flexible body is desirably also sufficiently robust to maintain its shape as shown in FIG. 4, when the flexible body is at rest with the entirety of the base 104 supported by a planar support surface (not shown). As illustrated, when the base is entirely supported by the planar support surface, the base is generally planar. The thickness of the material used to form the flexible body 102, the shape of the flexible body, and/or the traits of the material used to form the flexible body, can be chosen or designed to provide the features of the flexible body described herein. For example, in one embodiment, the flexible body 102 has (e.g., the base 104 and the side walls 106 each have) a thickness of about 3/32 inch. This thickness provides the necessary robustness for a flexible body 102 made of silicone such that the side walls 106 do not wilt, ripple, or ruffle when the side walls 106 form the seal with the food receiver side walls 20, as explained in more detail below. In other words, this robustness allows the side walls 106 to lay generally flat against the food receiver side walls 20 when the liner 100 is placed in the food receiver 12. Smaller thicknesses may not provide the necessary robustness, thereby causing the side walls 106 to ripple or ruffle against the food receiver side walls 20, substantially reducing the quality of the seal formed between the liner 100 and the food receiver 12. The flexible body 102 is desirably also resilient (e.g., resiliently deformable) such that if the flexible body were deformed, such as by slightly deforming by pushing in one of the side walls 106, the flexible body would resiliently return to its original shape (see FIG. 4).

The flexible body 102 has a length L and a width W. The length Lis measured between the upper edges of the front and rear side walls 106A, 106B (broadly, two opposing side walls) and the width W is measured between the upper edges of the left and right side walls 106C, 106D (broadly, another two opposing side walls). In other words, the length L and the width W of the flexible body 102 is measured at the rim 108. Desirably, the length L of the flexible body 102 is less than a length L_{C} of the food receiver cavity 16 and the width W of the flexible body is less than a width W_{C} of the food receiver cavity (when the flexible body 102 is at rest and the entirely of the base is supported by a planar surface). For example, in one embodiment, the length L and the width W of the flexible body are each about ⅛ inch less than the respective length L_{C} and width W_{C} of the food receiver cavity 16. The base 104 has a base length L_{B} and a base width W_{B}. The base length L_{B} is less than the length L of the flexible body 102 and the base width W_{B} is less than width W of the flexible body. Therefore, the base length L_{B} is less than the length L_{C} of the food receiver cavity 16 and the base width W_{B} is less than width W_{C} of the food receiver cavity. Desirably, the base length L_{B} is greater than a raised portion length L_{R} of the raised portion 22 of the floor 18 of the food receiver 12 and the base width W_{B} is greater than a raised portion width W_{R} of the raised portion of the floor of the food receiver. As will become apparent, these dimensions of the flexible body 102 facilitate the formation of the seal between the liner 100 and the food receiver 12. Flexible bodies having other configurations than described and illustrated herein can be used without departing from the scope of the present disclosure.

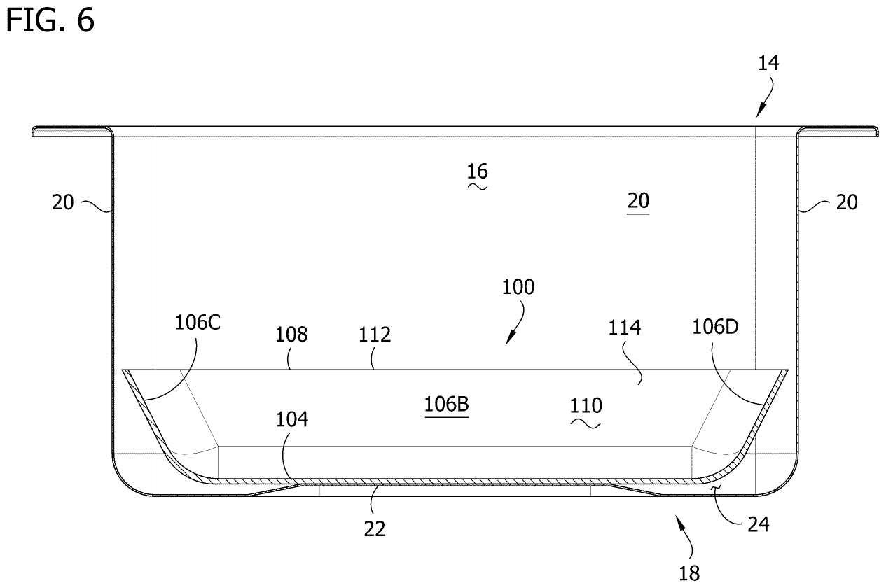

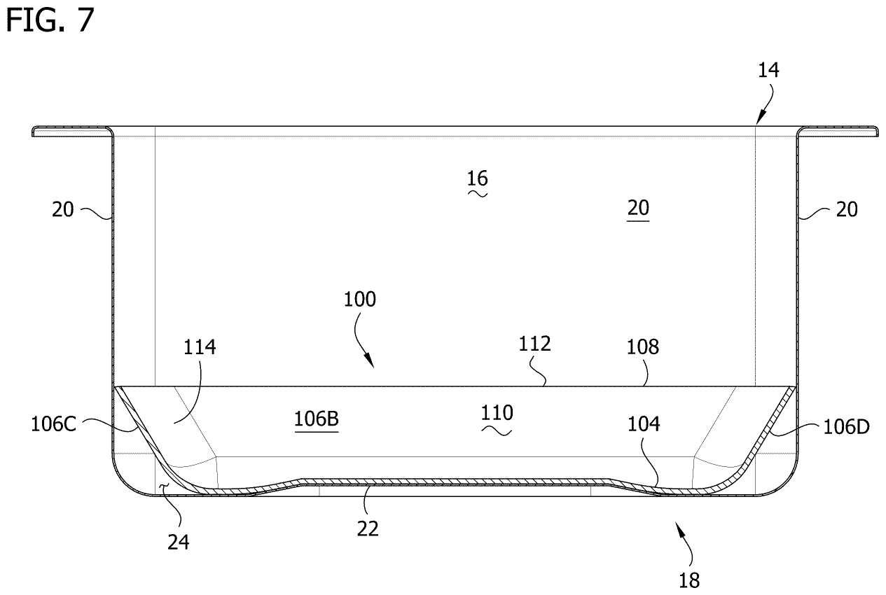

Referring to FIGS. 6 and 7, the flexible body 102 is configured to engage and form a seal with the food receiver 12 to collect generally all the food that may fall into the food receiver cavity 16. The side walls 106 are configured to move into engagement with the food receiver side walls 20 to generally prevent food from moving between the food receiver side walls and the sidewalls of the flexible body 102 when the flexible body is disposed in the food receiver cavity 16 of the food receiver 12. In particular, the side walls 106 form a seal with the food receiver side walls 10. Desirably, the rim 108 (e.g., upper edge margins of the side walls 106) engages and forms the seal with the food receiver side walls 20. The seal formed between the side walls 106 and the food receiver side walls 20 ensures the food will fall into the food receiving cavity 110 of the flexible body 102. Desirably, the side walls 106 (e.g., rim 108) form a complete perimeter seal around the food receiving cavity 16 with the food receiver side walls 20. However, it will be understood that sometimes a perfect fit may not be achieved between the side walls 106 of the liner 100 and the food receiver side walls 20, resulting in peripheral seal segments between the side walls and food receiver 12 with one or more gaps between the peripheral seal segments. Regardless of whether a complete or partial peripheral seal is made, the engagement between the side walls 106 of the flexible body 102 and the food receiver side walls 20 prevents most/all food from moving in-between the liner 100 and the food receiver 12 and collecting on the floor 18 of the food receiver.

As mentioned above, the length L and the width W of the flexible body 102 (e.g., the rim 108) is desirably less than the length L_{C} and the width W_{C} of the food receiver cavity 16, respectively. Accordingly, as generally shown in FIG. 6, at least some of the side walls 106 would be spaced apart from corresponding food receiver side walls 20 of the flexible body 102 stayed in the configuration shown in FIG. 6. Thus, to form the seal (e.g., continuous peripheral seal) between the flexible body 102 and the food receiver side walls 20, the side walls 106 move outward (e.g., sag) to engage the food receiver side walls and form the seal when the liner 100 is disposed (e.g., positioned or placed) in the food receiver cavity 16. To facilitate the movement of the side walls 106 toward (e.g., into engagement with) the food receiver side walls 20, the base 104 of the flexible body 102 is configured to be deformed by the raised portion 22 of the floor 18 of the food receiver 12. When the liner 100 is disposed (e.g., placed) in the food receiver cavity 16, the base 104 of the flexible body 102 generally conforms to the contours of the floor 18 (e.g., deforms around the raised portion 22). Specifically, the base 104 is deformed by the raised portion 22 of the floor 18. The base 104 (e.g., a center portion thereof) contacts and is supported by the raised portion 22 of the floor 18 of the food receiver 12. As a result, because the base 104 is larger (e.g., length, width) than the raised portion 22, an outer peripheral section of the base is unsupported by the raised portion of the floor 18. Due to the flexibility of the base 104 and the effects of gravity, this unsupported outer peripheral section of the base falls or sags downward into the perimeter recess 24 of the floor 18. Due to this deformation of the base 104 around the raised portion 22 of the floor 18 of the food receiver 12, the side walls 106 move outward toward and into engagement with the food receiver side walls 20, as shown in FIG. 7. The deformation of the base 104 increases the skew angle (relative to the vertical) of the side walls 106 thereby moving the side walls outward. The outward movement of the side walls 106 is further facilitated by the outward tapering (e.g., outward skew angle) of the side walls, causing the side walls to fall or sag outward. The outward tapering of the side walls results in the upper edge margins of the side walls naturally tending to move outward, due to the center of gravity of each side wall being disposed laterally outboard of the base 104. This natural tendency for the side walls 106 to move outward results in the side walls moving outward when the base 104 deforms over the raised portion 22 of the floor 18. This outward movement biases the rim 108 (e.g., the upper edge margins of each side wall 106) toward sealing engagement with the inner surfaces of the food receiver side walls 20. Accordingly, when the liner 100 is in the food receiver cavity 16, the side walls 106 move outward into sealing engagement with the food receiver 12. This sealing configuration is shown in FIG. 7. As illustrated, in this embodiment, the seal between the flexible body 102 and the food receiver 12 is generally formed around the rim 108 of the liner 100 (e.g., the upper edge margins of the side walls 106).

When the liner 100 is in the sealing configuration, as shown in FIG. 7, the base 104 of the liner rests on the floor 18 of the food receiver 12. The base 104 rests on the raised portion 22 and sags into the perimeter recess 24. In the illustrated embodiment, the base 104 is shown resting on the portion of the floor 18 defining the bottom of the perimeter recess 24. It will be appreciated that the base 104 of the liner 100, although deformed and falling into the perimeter recess 24, may remain spaced above the portion of the floor 18 defining the bottom of the perimeter recess due to the rim 108 of the flexible body 102 engaging the food receiver side walls 20. The base 104 of the liner 100 may continually seek to sag farther downward into the perimeter recess 24, such that the rim 108 of the flexible body 102 is continually biased against the food receiver side walls 20 to maintain and form a more robust sealing engagement (e.g., seal) between the liner and the food receiver 12.

In the sealing configuration, desirably a continuous perimeter seal around the entire rim 108 of the flexible body 102 is formed with the food receiver 12 to prevent food (e.g., solids and liquids) from passing therebetween. Therefore, any food that falls into the food receiver 12, falls into and is collected by the liner 100. This makes it easier to clean the food receiver, by simply removing the liner 100 and any food collected thereby from the food receiver. This also prevents the food from falling into the food receiver 12 and resting on the floor 18 of the food receiver. Any food resting on the floor 18 may burn and/or become stuck to the floor. The liner 100 prevents this from happening. Moreover, the non-stick surface of the liner 100 makes it easier to clean should any food collected by the liner be burned by the heating element of the food receiver 12. Also, the flexibility of the liner facilitates manual deformation of the liner to break food away from the liner.

The movement of the side walls 106 and the formation of the perimeter seal between the liner 100 and the food receiver 12 may be further facilitated by the heating of the food receiver (to heat the food held in the trays), which in turn heats the flexible body 102, making it easier for the flexible body to deform. For example, when the liner 100 is first installed in the food receiver 12, there may be one or more gaps between the rim 108 of the flexible body 102 and the food receiver side walls 20, such as at the corners of the liner and food receiver cavity 16. But after the liner 100 is heated, the liner may expand and/or further deform and close the gaps.

It has been found that configuring the liner 100 to provide the tapering and outward movement of the side walls 106 to form the seal is more desirable compared to a liner having a rim and/or side walls that closely conform to or directly match the size and shape of the food receiver cavity 16 because such a liner may not form a sufficient seal. Instead, what tends to occur with directly matched liners is that their walls tend to ripple or get wavy when engaged with the food receiver side walls 20, preventing the formation of the continuous perimeter seal.

Testing has shown the liner 100 provides an insulative effect to the food receiver cavity 16. Although heat from a heat source or heater (e.g., a heating element and optional heat distribution, such as an aluminum plate) below the floor 18 of the food receiver 12 may need to pass upward through the liner 100 to heat the air in the food receiver cavity 16 about the liner, the liner does not significantly block transmission of the concentrated heat emanating from the heater into the food receiver cavity. In fact, any insulative effect by the liner 100 is easily overcome due to the continued heating provided by the heater, which heats the liner to generally the same desired temperature of the air in the food receiver cavity 16. The liner 100 may also serve to insulate the heated air in the food receiver cavity 16 and prevent transmission of heat downward and laterally out of the food receiver cavity (e.g., via passing through the metal walls and floor 18 of the food receiver pan 14 covered by the liner).

Other configurations of the liner can be used without departing from the scope of the present disclosure. For example, the liner can have taller side walls. In another example, the side walls of the liner may not be coupled together at the corners of the liner.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A liner for a food tray receiver of a food holding apparatus, the food tray receiver having a plurality of food tray receiver side walls defining a food tray receiver cavity for receiving one or more trays of food, the liner comprising:
a flexible body sized and shaped to be inserted into the food tray receiver cavity of the food tray receiver, the flexible body having a base and a plurality of body side walls extending generally upward from the base, the flexible body having a food receiving cavity defined by the base and the plurality of body side walls, the food receiving cavity having an open top configured to receive food when the flexible body is disposed in the food tray receiver and food falls toward the flexible body, the body side walls configured to move into engagement with the food tray receiver side walls to generally prevent food from moving between the food tray receiver side walls and the body side walls when the flexible body is disposed in the food tray receiver cavity of the food tray receiver.

2. The liner of claim 1, wherein the body side walls are configured to form a seal with the food tray receiver side walls.

3. The liner of claim 2, wherein the body side walls are configured to form a complete perimeter seal around the food receiving cavity with the food tray receiver side walls.

4. The liner of claim 1, wherein the flexible body includes a rim, the rim defined by upper edge margins of the plurality of body side walls, the rim being configured to move into engagement with and form a seal with the food tray receiver side walls to generally prevent food from moving between the food tray receiver side walls and the rim of the flexible body when the flexible body is disposed in the food tray receiver cavity of the food tray receiver.

5. The liner of claim 1, wherein the base is configured to be deformed by a raised portion of a floor of the food tray receiver to facilitate the movement of the plurality of side walls into engagement with the food tray receiver side walls.

6. The liner of claim 1, wherein each body side wall of the plurality of body side walls tapers outward as said body side wall extends generally upward away from the base.

7. The liner of claim 1, in combination with the food holding apparatus, wherein the flexible body has a length and a width, the length measured between upper edges of two opposing body side walls of the plurality of body side walls and the width measured between upper edges of two other opposing body side walls of the plurality of body side walls, and
wherein the length of the flexible body being less than a length of the food tray receiver cavity when the flexible body is at rest outside the food tray receiver cavity and the entirety of the base is supported by a planar surface, or the width of the flexible body being less than a width of the food receiver cavity when the flexible body is at rest outside the food tray receiver cavity and the entirety of the base is supported by the planar surface.

8. The liner of claim 1, wherein the flexible body has a length and a width, the length measured between upper edges of two opposing body side walls of the plurality of body side walls and the width measured between upper edges of two other opposing body side walls of the plurality of body side walls, wherein the base has a base length and a base width, the base length being less than the length of the flexible body and the base width being less than the width of the flexible body.

9. The liner of claim 1, wherein the base includes opposite front and rear side edge margins and opposite left and right side edge margins, the plurality of body side walls including a front side wall extending from the front edge margin of the base, a rear side wall extending from the rear side edge margin of the base, a left side wall extending from the left side edge margin of the base, and a right side wall extending from the right side edge margin of the base.

10. The liner of claim 1, wherein the flexible body is a unitary, one-piece component.

11. The liner of claim 1, wherein the flexible body comprises silicone.

12. The liner of claim 1, wherein the base and the plurality of body side walls are each about 3/32 inch thick.

13. The liner of claim 1, wherein the flexible body includes an interior surface defining the cavity, the interior surface defined by the base and the plurality of side walls, the interior surface being free of any crevices and sharp corners.

14. A liner for a food tray receiver of a food holding apparatus, the food tray receiver having a plurality of food tray receiver side walls defining a food tray receiver cavity for receiving one or more trays of food, the liner comprising:
a flexible body sized and shaped to be inserted into the food tray receiver cavity of the food tray receiver, the flexible body having a base and a plurality of body side walls extending generally upward from the base, the flexible body having a food receiving cavity defined by the base and the plurality of body side walls, the food receiving cavity having an open top configured to receive food when the flexible body is disposed in the food tray receiver and food falls toward the flexible body, the body side walls configured to engage the food tray receiver side walls when received in the food tray receiver cavity to obstruct food from moving between the food tray receiver side walls and the body side walls, wherein the body side walls taper outward as the body side walls extend generally upward away from the base.

15. The liner of claim 14, wherein the body side walls are configured to form a seal with the food tray receiver side walls.

16. The liner of claim 15, wherein the body side walls are configured to form a complete perimeter seal around the food receiving cavity with the food tray receiver side walls.

17. The liner of claim 14, wherein the flexible body includes a rim, the rim defined by upper edge margins of the plurality of body side walls, the rim being configured to move into engagement with and form a seal with the food tray receiver side walls to generally prevent food from moving between the food tray receiver side walls and the rim of the flexible body when the flexible body is disposed in the food tray receiver cavity of the food tray receiver.

18. The liner of claim 14, wherein the base is configured to be deformed by a raised portion of a floor of the food tray receiver to facilitate movement of the plurality of side walls into engagement with the food tray receiver side walls.

19. The liner of claim 14, wherein the flexible body is constructed to permit gravity acting on the body side walls to bias the side walls against respective food tray receiver side walls when the liner is in the food tray receiver.

20. The liner of claim 14, wherein the base of the flexible body is configured to be deformable to cause the flexible body to deform outward to engage the food tray receiver side walls.
